(19) United States
(12) Patent Application Publication
(10) Pub. No.: US 2015/0201633 A1
(43) Pub. Date: Jul. 23, 2015

(54) AGENT FOR PRESERVING QUALITY OF PEELED AND/OR CUT VEGETABLE OR FRUIT AND/OR SEAFOOD

(71) Applicant: ORIENTAL YEAST CO., LTD., Tokyo (JP)

(72) Inventors: Hiromi Urasaki, Tokyo (JP); Osamu Oka, Tokyo (JP); Masaru Onda, Tokyo (JP)

(21) Appl. No.: 14/417,436

(22) PCT Filed: Jul. 25, 2013
(86) PCT No.: PCT/JP2013/070248

§ 371 Date: Jan. 26, 2015

(30) Foreign Application Priority Data
Jul. 26, 2012 (JP) 2012-166417

(51) Int. Cl. A23B 4/12; A23L 3/3535; A23L 3/3508; A23B 7/10

(52) U.S. Cl. CPC A23B 4/12; A23B 7/10; A23L 3/3535; A23L 3/3508; A23V 2002/00

(57) ABSTRACT

[Problem] To provide: a novel quality-preserving agent which can preserve the quality of a peeled and/or cut vegetable or fruit or seafood during storage in a simple manner and effectively and is highly safe; and others.

[Solution] The quality-preserving agent contains two components, i.e., sodium acetate and α-lipoic acid, as active ingredients. The quality-preserving agent can prevent the discoloration, brownish discoloration or the like of a peeled and/or cut vegetable or fruit or seafood during chilled storage and ambient-temperature storage of the vegetable or fruit or the seafood, can improve the shelf life of the vegetable or fruit or the seafood, and can preserve the quality of the vegetable or fruit or the seafood in a simple manner and effectively merely by bringing the vegetable or fruit or the seafood into contact with the quality-preserving agent.

### TECHNICAL FIELD

The present invention relates to a quality-preserving agent which can preserve the quality of a peeled and/or cut vegetable or fruit (a vegetable which has been peeled, cut, or peeled and cut; or a fruit which has been peeled, cut, or peeled and cut) or seafood during storage in a simple manner and effectively; and a method for preserving the quality of a peeled and/or cut vegetable or fruit or seafood using the agent.

### BACKGROUND ART

A peeled and/or cut vegetable or fruit may have a problem in quality caused by discoloration or brownish discoloration (color change to tan (brown) by an action of an enzyme, or Maillard reaction or caramelization) during storage. For example, in a cut lettuce used for sandwich, there has been found a phenomenon of brownish discoloration or reddish discoloration around a core and on a leaf thereof during not only ambient-temperature storage but also chilled storage. The reddish discoloration has also been found in a cut burdock and a cut taro. In a cut avocado, a cut eggplant, a cut banana, and a cut potato, blackish discoloration has been found. In a peeled and cut apple, usually, brownish discoloration is rapidly caused from a cut section thereof, unless subjected to a special treatment.

The discoloration or brownish discoloration of such peeled and/or cut vegetables or fruits is said to be caused by oxidation of polyphenols contained therein. However, a variety of types of polyphenols is contained depending on a type of vegetable or fruit and reaction mechanisms thereof are also various. Moreover, other substances (e.g., enzyme) than the polyphenols have been reported to participate in the discoloration or brownish discoloration. Therefore, the discoloration or brownish discoloration is not easily suppressed because different approaches are often required in accordance with the type of vegetable or fruit.

As methods for preventing the discoloration or brownish discoloration (preserving the quality) of the peeled and/or cut vegetable or fruit, there have been disclosed a method using an onion extract with supercritical/subcritical CO₂ (PTL 1), a method using allyl isothiocyanate, ethyl alcohol, and edible fat and oil (PTL 2), and a method using table salt and ascorbic acid (PTL 3).

However, the above methods often exhibit an unsatisfactory effect. In particular, use of ascorbic acid (or ascorbate) often promotes the quality deterioration (e.g., discoloration or brownish discoloration) in some types of vegetables or fruits, conversely. In seafood, there has also been a major problem of discoloration in, for example, a fillet during storage as with the peeled and/or cut vegetable or fruit. However, there are few simple and effective solutions in the present circumstances. In recent years, a technology is needed that can preserve the quality of the peeled and/or cut vegetable or fruit or the seafood in not only a chilled temperature zone but also an ambient-temperature zone. Therefore, there is a need in the art to develop a novel quality-preserving agent which contains highly safe active ingredients (e.g., active ingredients which have been commonly eaten) and which can preserve the quality of a variety of peeled and/or cut vegetables or fruits and seafood during storage in various temperature zones in a simple manner and effectively and stably.

### CITATION LIST

### Patent Literature

PTL 1: Japanese Patent Application Laid-Open (JP-A) No. 2004-173590

PTL 2: JP-A No. 10-298003

PTL 3: JP-A No. 10-108619

### SUMMARY OF INVENTION

### Technical Problem

The present invention has been made in view of the foregoing background art, and aims to provide a quality-preserving agent which can preserve the quality of a peeled and/or cut vegetable or fruit or seafood during storage in a simple manner and effectively and which is highly safe.

### Solution to Problem

The present inventors conducted extensive studies to achieve the above object, and have found that use of two components, i.e., sodium acetate and α-lipoic acid, as active ingredients makes it possible to preserve the quality of a variety of types of peeled and/or cut vegetables or fruits or seafood during chilled storage and ambient-temperature storage in a simple manner and effectively (prevent the discoloration or brownish discoloration during storage in a simple manner and effectively, improve the shelf life, and preserve color, freshness and juiciness, and taste and flavor). Thus, the present invention has been accomplished.

Embodiments of the present invention are as follows.

(1) A quality-preserving agent for a peeled and/or cut vegetable or fruit, and/or seafood, comprising the following two components: sodium acetate; and α-lipoic acid, as active ingredients.
(2) A quality-preserving agent for a peeled and/or cut vegetable or fruit, and/or seafood, consisting of the following two components: sodium acetate; and α-lipoic acid, as active ingredients for quality preservation.
(3) The agent according to (1) or (2), wherein the agent is brought into contact with the peeled and/or cut vegetable or fruit or the seafood in the form of a solution having a compositional ratio of 0.01% (w/v) to 10.0% (w/v) of sodium acetate and 0.01% (w/v) to 10.0% (w/v) of α-lipoic acid.
(4) The agent according to (1) or (2), wherein the agent is brought into contact with the peeled and/or cut vegetable or fruit or the seafood in the form of a solution having a compositional ratio of 0.1% (w/v) to 2.0% (w/v) (preferably 0.5% (w/v) to 1.5% (w/v)) of sodium acetate and 0.03% (w/v) to 0.5% (w/v) (preferably 0.05% (w/v) to 0.2% (w/v)) of α-lipoic acid.
(5) The agent according to any one of (1) to (4), wherein the agent exhibits quality preservation which is prevention of discoloration (suppression of discoloration and/or brownish discoloration), improvement of shelf life, or both thereof.
(6) The agent according to (5), wherein the agent prevents discoloration of at least one selected from the group consisting of a cut lettuce, a cut cabbage, a cut crown daisy, a cut Chinese cabbage, a cut mushrooms, a peeled and/or cut avocado, a peeled and/or cut banana, a peeled and/or cut potato, a peeled and/or cut sweet potato, a peeled and/or cut burdock, a peeled and/or cut eggplant, a peeled and/or cut apple, a peeled and/or cut Chinese yam, a peeled and/or cut giant butterbur, a peeled and/or cut lotus root, a peeled and/or cut tomato, a peeled and/or cut taro, a peeled and/or cut pear, a peeled and/or cut peach, a peeled and/or cut loquat, a peeled and/or cut radish, salmons, tunas, Pacific ocean perch, horse mackerel, Atka mackerel, and mackerels during storage at 4° C. to 30° C. (in particular, 10° C. to 20° C.).
(7) A method for preserving quality of a peeled and/or cut vegetable or fruit and/or seafood, comprising:

treating the peeled and/or cut vegetable or fruit, or the seafood with a solution (e.g., aqueous solution) containing, as active ingredients, 0.01% (w/v) to 10.0% (w/v) of sodium acetate and 0.01% (w/v) to 10.0% (w/v) of α-lipoic acid through at least one selected from the group consisting of immersion, spraying, and coating.

(8) The method according to (7), wherein the solution is a solution (e.g., aqueous solution) containing, as active ingredients, 0.1% (w/v) to 2.0% (w/v) (preferably 0.5% (w/v) to 1.5% (w/v)) of sodium acetate and 0.03% (w/v) to 0.5% (w/v) (preferably 0.05% (w/v) to 0.2% (w/v)) of α-lipoic acid.
(9) The method according to (7) or (8), wherein the solution is a solution (e.g., aqueous solution) containing, as active ingredients for quality preservation, 0.01% (w/v) to 10.0% (w/v) of sodium acetate and 0.01% (w/v) to 10.0% (w/v) of α-lipoic acid, and no other active ingredients for quality preservation.
(10) The method according to any one of (7) to (9), wherein the solution is a solution (e.g., aqueous solution) containing, as active ingredients for quality preservation, 0.1% (w/v) to 2.0% (w/v) (preferably 0.5% (w/v) to 1.5% (w/v)) of sodium acetate and 0.03% (w/v) to 0.5% (w/v) (preferably 0.05% (w/v) to 0.2% (w/v)) of α-lipoic acid, and no other active ingredients for quality preservation.
(11) The method according to any one of (7) to (10), wherein the method exhibits quality preservation which is prevention of discoloration (suppression of discoloration and/or brownish discoloration), improvement of shelf life, or both thereof.
(12) The method according to (11), wherein the method prevents discoloration of at least one selected from the group consisting of a cut lettuce, a cut cabbage, a cut crown daisy, a cut Chinese cabbage, a cut mushrooms, a peeled and/or cut avocado, a peeled and/or cut banana, a peeled and/or cut potato, a peeled and/or cut sweet potato, a peeled and/or cut burdock, a peeled and/or cut eggplant, a peeled and/or cut apple, a peeled and/or cut Chinese yam, a peeled and/or cut giant butterbur, a peeled and/or cut lotus root, a peeled and/or cut tomato, a peeled and/or cut taro, a peeled and/or cut pear, a peeled and/or cut peach, a peeled and/or cut loquat, a peeled and/or cut radish, salmons, tunas, Pacific ocean perch, horse mackerel, Atka mackerel, and mackerels during storage at 4° C. to 30° C. (in particular, 10° C. to 20° C.).

### Advantageous Effects of Invention

According to the present invention, a variety of types of peeled and/or cut vegetables or fruits or seafood during chilled storage and ambient-temperature storage (e.g., storage in the wide range of temperature, for example, from 4° C. to 30° C., in particular, from 10° C. to 20° C., in more particular, an ambient-temperature range from 15° C. to 20° C.) can be prevented in discoloration or brownish discoloration (at least one or more selected from the group consisting of reddish discoloration, dark-brownish discoloration, blackish discoloration, dark-reddish discoloration, and decolorization) in a simple manner and effectively and stably; can be improved in the shelf life; and can be preserved in their quality (e.g., color, and freshness and juiciness). The invention is not problematic in safety, and has no impact on taste and flavor of the peeled and/or cut vegetable or fruit or the seafood.

### BRIEF DESCRIPTION OF DRAWINGS

FIG. 1 shows photographs, as substitutes for drawings, illustrating changes in color tones of pieces of peeled and cut apple during storage at 20° C. for 48 hours. The left column shows immediately after treatment, the middle column shows 24 hours after treatment, and the right column shows 48 hours after treatment. Photographs of Non-additive product, Test product I, Test product II, Test product III, and Comparative product are shown from the top to the bottom (the same applies to FIGS. 2 to 4).

FIG. 2 shows photographs, as substitutes for drawings, illustrating changes in color tones of pieces of peeled and cut burdock during storage at 20° C. for 48 hours.

FIG. 3 shows photographs, as substitutes for drawings, illustrating changes in color tones of pieces of cut lettuce during storage at 20° C. for 48 hours.

FIG. 4 shows photographs, as substitutes for drawings, illustrating changes in color tones of pieces of peeled and cut avocado during storage at 20° C. for 48 hours.

FIG. 5 shows photographs, as substitutes for drawings, illustrating changes in color tones of pieces of peeled and cut avocado during storage at 20° C. for 72 hours. Photographs of Non-additive product, Test product III, and Control product (0.1% α-lipoic acid) are shown from the top to the bottom. In the column “Evaluation,” − denotes no brownish discoloration, + denotes some brownish discoloration, ++ denotes brownish discoloration to a greater extent than +, +++ denotes brownish discoloration to a greater extent than ++, and ++++ denotes overall brownish discoloration (the same applies to FIGS. 6 to 10 except for storage duration).

FIG. 6 shows photographs, as substitutes for drawings, illustrating changes in color tones of pieces of peeled and cut banana during storage at 20° C. for 48 hours.

FIG. 7 shows photographs, as substitutes for drawings, illustrating changes in color tones of pieces of cut mushroom during storage at 20° C. for 72 hours.

FIG. 8 shows photographs, as substitutes for drawings, illustrating changes in color tones of pieces of cut eggplant during storage at 20° C. for 48 hours.

FIG. 9 shows photographs, as substitutes for drawings, illustrating changes in color tones of pieces of cut Chinese cabbage during storage at 20° C. for 72 hours.

FIG. 10 shows photographs, as substitutes for drawings, illustrating changes in color tones of pieces of peeled and cut radish during storage at 20° C. for 72 hours.

FIG. 11 shows photographs, as substitutes for drawings, illustrating changes in color tones of pieces of peeled and cut peach during storage at 20° C. for 7 days. Photographs of Non-additive product and Test product III are shown from the top to the bottom. Evaluation was performed in the same manner as in FIGS. 5 to 10.

FIG. 12 shows photographs, as substitutes for drawings, illustrating changes in color tones of pieces of peeled and cut pear during storage at 20° C. for 48 hours. Photographs of Non-additive product, Existing product, Test product III, and Control product (0.1% α-lipoic acid) are shown from the top to the bottom. Evaluation was performed in the same manner as in FIGS. 5 to 11 (the same applies to FIGS. 13 to 21 except for storage duration).

FIG. 13 shows photographs, as substitutes for drawings, illustrating changes in color tones of pieces of peeled and cut apple during storage at 20° C. for 48 hours.

FIG. 14 shows photographs, as substitutes for drawings, illustrating changes in color tones of pieces of cut cabbage during storage at 20° C. for 48 hours.

FIG. 15 shows photographs, as substitutes for drawings, illustrating changes in color tones of pieces of cut lettuce during storage at 20° C. for 48 hours.

FIG. 16 shows photographs, as substitutes for drawings, illustrating changes in color tones of pieces of cut crown daisy during storage at 20° C. for 48 hours.

FIG. 17 shows photographs, as substitutes for drawings, illustrating changes in color tones of pieces of peeled and cut taro during storage at 20° C. for 72 hours.

FIG. 18 shows photographs, as substitutes for drawings, illustrating changes in color tones of pieces of peeled and cut burdock during storage at 20° C. for 48 hours.

FIG. 19 shows photographs, as substitutes for drawings, illustrating changes in color tones of pieces of peeled and cut potato during storage at 20° C. for 48 hours.

FIG. 20 shows photographs, as substitutes for drawings, illustrating changes in color tones of pieces of peeled and cut Chinese yam during storage at 20° C. for 72 hours.

FIG. 21 shows photographs, as substitutes for drawings, illustrating changes in color tones of pieces of peeled and cut lotus root during storage at 20° C. for 48 hours.

### DESCRIPTION OF EMBODIMENTS

Firstly, in the present invention, the two components: sodium acetate and α-lipoic acid which have been actually used as a food additive and which have been commonly eaten as food are used as active ingredients of a quality-preserving agent for a peeled and/or cut vegetable or fruit, or seafood.

The sodium acetate may be a product purified to a certain extent or a synthetic product. Alternatively, it may be a commercially available product (food additive). In this case, it preferably has the purity above a certain degree (e.g., 90% or higher, preferably 95% or higher).

The α-lipoic acid is also referred to as thioctic acid, and is a sulfur-containing vitamin-like substance which is found widely in bodies of animals and plants and which serves as, for example, a coenzyme. It has been eaten as a material of a dietary supplement and was approved as a food additive in 2004. It may also be a commercially available product having the purity above a certain extent.

Note that, it has a high antioxidative activity, and is characterized by having an action of reducing polyphenols oxidized by polyphenol oxidase.

In the invention, in the case where only one of either α-lipoic acid or sodium acetate is contained as the active ingredient, the intended effect is not sufficiently exhibited. The intended effect is sufficiently exhibited only when the two components are used in combination. Note that, use of other active ingredients for quality preservation (e.g., organic acid salts such as sodium citrate and sodium tartrate; and alum) in combination with the two components is not completely excluded. However, it is suitable to contain only sodium acetate and α-lipoic acid as the active ingredients. Moreover, use of ascorbic acid (including ester thereof) or ascorbate in combination is not preferable because a satisfactory effect may be exhibited or, conversely, quality deterioration such as discoloration may be promoted. Therefore, it is the most suitable not to use (comprise) ascorbic acid or ascorbate.

Additionally, for example, it is acceptable to contain, as the active ingredients, α-lipoic acid in combination with an alkali metal carboxylate other than sodium acetate (and optionally an additional active ingredient) as long as a quality-preserving effect can be exhibited.

In the invention, sodium acetate and α-lipoic acid are more preferably used in combination within a predetermined range of compounding ratios. Specifically, they are suitably brought into contact with the peeled and/or cut vegetable or fruit in the form of a solution having a compositional ratio of 0.01% (w/v) to 10.0% (w/v) (preferably 0.1% (w/v) to 2.0% (w/v), further preferably 0.5% (w/v) to 1.5% (w/v)) of sodium acetate and 0.01% (w/v) to 10.0% (w/v) (preferably 0.03% (w/v) to 0.5% (w/v), more preferably 0.05% (w/v) to 0.2% (w/v)) of α-lipoic acid.

In the invention, sodium acetate and α-lipoic acid are preferably formed into a mixed formulation. The formulation may consist of the above components or may contain a formulation aid as a non-active raw material for formulating in addition to the above components. The formulation aid is not particularly limited. Preferable examples thereof include table salt, polysaccharides (e.g., dextrin), and an emulsifier. Note that, the two components may be used individually in predetermined amounts without formulating during production of the solution.

The vegetable or fruit intended to preserve its quality in the invention is a vegetable or fruit which is used for various food in the peeled and/or cut form. That is, a vegetable or fruit which is eaten as it is without being peeled or cut is excluded.

Examples thereof include, but is not limited thereto, a cut lettuce (e.g., cut iceberg lettuce, cut leaf lettuce, or cut cos lettuce), a peeled and/or cut burdock, and a peeled and/or cut taro which have a problem of reddish discoloration during storage; a peeled and/or cut apple, a peeled and/or cut lotus root, a peeled and/or cut sweet potato, a peeled and/or cut Chinese yam, a peeled and/or cut peach, a peeled and/or cut loquat, and a peeled and/or cut radish which have a problem of dark-brownish discoloration during storage; a cut cabbage, a cut crown daisy, a cut mushrooms, a peeled and/or cut avocado, a peeled and/or cut banana, a peeled and/or cut potato, a peeled and/or cut eggplant, a peeled and/or cut pear, and a cut Chinese cabbage which have a problem of blackish discoloration during storage; a peeled and/or cut giant butterbur which easily undergoes dark-reddish or dark-brownish discoloration; and a peeled and/or cut tomato which has a problem of blackish discoloration or decolorization during storage. Perishable food with or without freezing is suitably treated, but processed products thereof (e.g., boiled, steamed, baked or seasoned product) may also be intended for the treatment.

Examples of the seafood intended to preserve its quality in the invention include, but is not limited thereto, salmons, tunas, Pacific ocean perch, horse mackerel, Atka mackerel, and mackerels. Perishable food with or without freezing is suitably treated, but processed products thereof (e.g., boiled, steamed, baked or seasoned product) may also be intended for the treatment. In particular, a suitable effect is achieved against seafood with skin removed and/or cut (e.g., a fillet).

The agent of the invention is used by bring into contact with the peeled and/or cut vegetable or fruit, or the seafood in the form of a solution. Water is preferably used as a solvent to thereby form an aqueous solution. However, other solvents may be used as long as sodium acetate and α-lipoic acid can be dissolved or uniformly suspended and dispersed thereinto and they can be safely utilized for food (e.g., aqueous solution containing a sterilizing ingredient such as ethanol or hypochlorous acid, oil-containing solution, and emulsifier-containing solution). A temperature of the solution may be from chilled temperature to ambient-temperature (e.g., 4° C. to 30° C.), and the solution is not necessary to be heated. A pH value is preferably near neutral (e.g., pH value in the range of 6 to 8), but this is not intended to exclude other pH values.

As previously described, the agent of the invention is preferably in the form of a formulation (e.g., microgranule, granule, and tablet). However, the agent may be in the form of a liquid formulation which has been previously formed into a solution in view of operability before the treatment. Other forms (e.g., gel and paste) may be used as long as there is no problem of operability. In the case where the agent is in any form other than some liquid formulations at a certain concentration, as mentioned above, the agent is dissolved into a solvent (e.g., water) so as to give a predetermined concentration to thereby form a solution at the predetermined concentration before use.

Note that, the term “quality preservation,” as used herein, means, in a perishable or freezed peeled and/or cut vegetable or fruit or seafood, prevention or suppression of discoloration or brownish discoloration (at least one or more selected from the group consisting of reddish discoloration, dark-brownish discoloration, blackish discoloration, dark-reddish discoloration, and decolorization) (i.e., color retention); or, in addition thereto, at least one selected from the group consisting of moisture retention (retention of freshness and juiciness), prevention or suppression of deterioration in taste and flavor, and improvement of the shelf life.

According to the invention, a variety of peeled and/or cut vegetable or fruit or seafood can be prevented in discoloration or brownish discoloration during storage in a simple manner and effectively and stably; can be improved in the shelf life; and can be preserved in their quality. The invention is not problematic in safety, and has no impact on taste and flavor of the peeled and/or cut vegetable or fruit or the seafood, because components which have been commonly eaten as food are only contained therein.

### EXAMPLES

Examples of the invention will now be described, but the invention is not limited thereto. The invention may be modified in various ways within the scope of technical ideas of the invention.

### Example 1

### Quality Verification Test of Various Cut Vegetables and Fruits I

The following test was performed to verify a quality-preserving effect of the invention against a peeled and cut apple, a peeled and cut burdock, a cut lettuce, and a peeled and cut avocado.

The vegetable or fruit was peeled and/or cut, and optionally sterilized and washed, followed by immersing into each of treatment liquids for 10 min. The following 5 treatment liquids were used: water (“Non-additive product”); three inventive products, i.e., a solution prepared to contain, as active ingredients, 0.1% (w/v) of sodium acetate and 0.01% (w/v) of α-lipoic acid (“Test product I”), a solution prepared to contain, as active ingredients, 0.2% (w/v) of sodium acetate and 0.02% (w/v) of α-lipoic acid (“Test product II”), and a solution prepared to contain, as active ingredients, 1.0% (w/v) of sodium acetate and 0.1% (w/v) of α-lipoic acid (“Test product III”); and a solution prepared to contain 0.25% (w/v) of sodium citrate, 0.2% (w/v) of sodium tartrate, 0.025% (w/v) of α-lipoic acid, and 0.525% (w/v) of alum (“Comparative product”). After the immersing, the vegetable or fruit was drained and stored at 20° C. for 48 hours. The vegetable or fruit was inspected at the start of storage (immediately after the treatment), after 24 hours of storage, and after 48 hours of storage. Results were compared to that of Control product (untreated product immediately after cutting) by visual inspection and by measuring color differences (L* value (lightness), a* value, and b* value (hue)) using a color-difference meter (spectrophotometer CM-3500 D, KONICA MINOLTA, INC.).

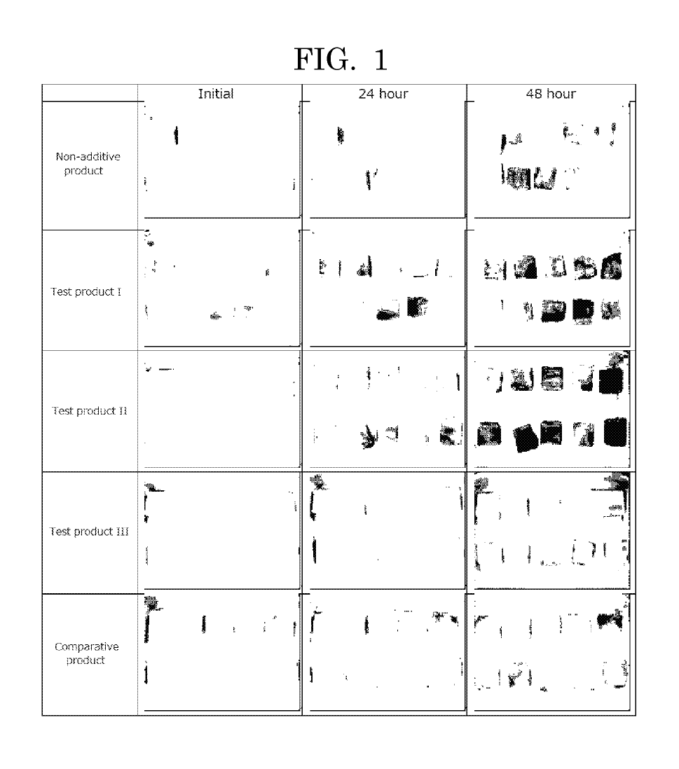

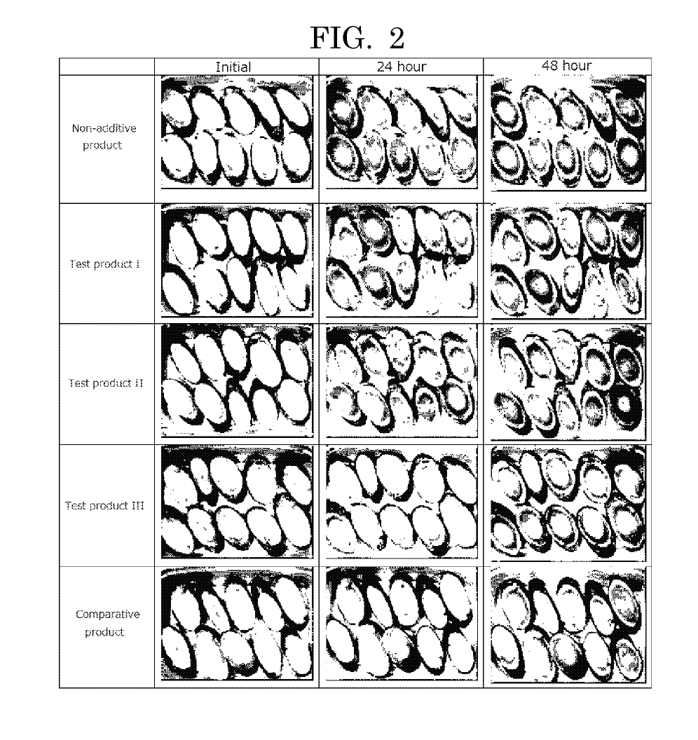

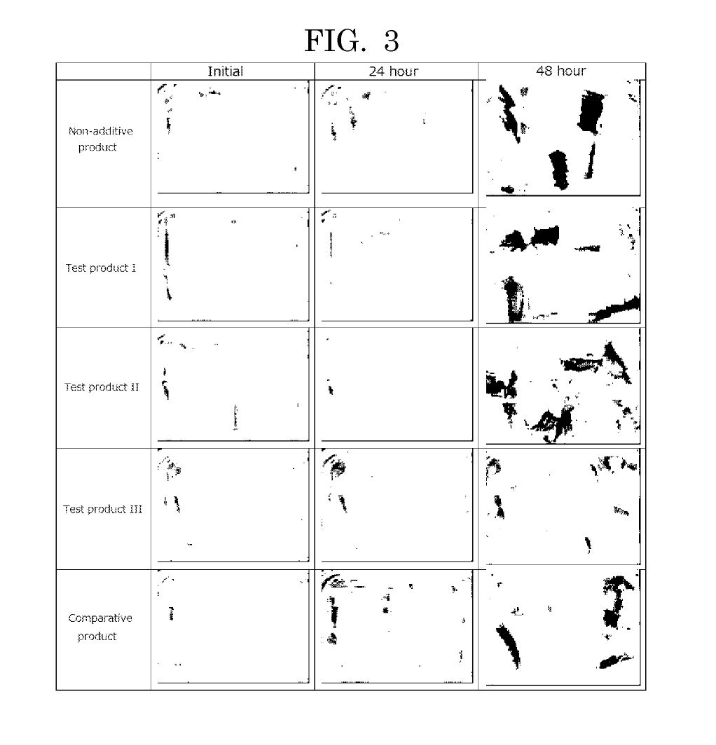

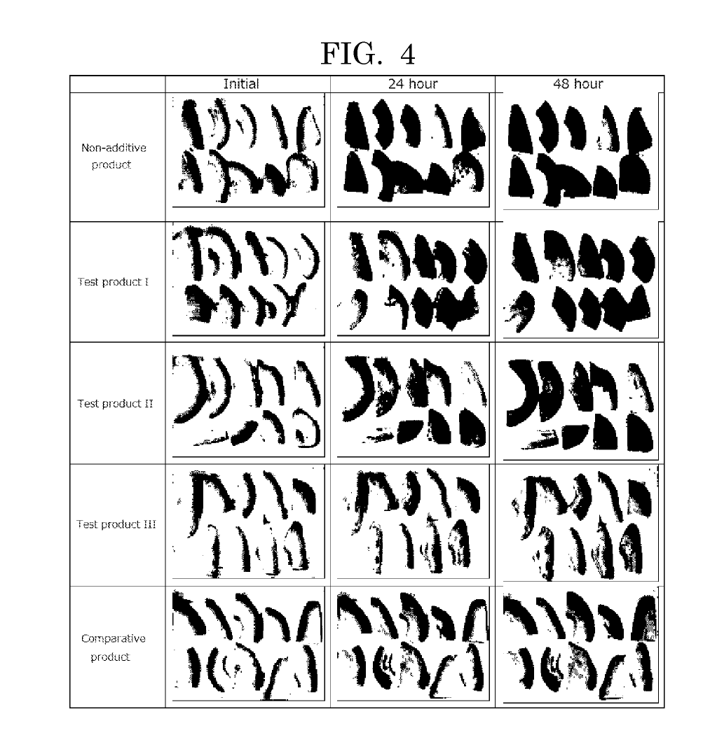

Results are shown in FIGS. 1 to 4 and Table 1 to 5. Note that, FIGS. 1 to 4 show photographs comparing samples of apple, burdock, lettuce, and avocado, respectively. Table 1 summarizes visual inspection results of the samples. Tables 2 to 5 show measuring results of samples of apple, burdock, lettuce, and avocado, respectively, using the color-difference meter. From the results, for results after 24 hours of storage at 20° C., Test products I to III and Comparative product all suppressed brownish discoloration in all of apple, burdock, lettuce, and avocado compared to Non-additive product. For results after 48 hours of storage at 20° C., Test product III and Comparative product suppressed brownish discoloration. For the peeled and cut apple, brownish discoloration was remarkably suppressed especially in Test product III and Test product III also gave the most similar result to that of Control product in the color difference measurement. For the peeled and cut burdock, brownish discoloration was remarkably suppressed especially in Comparative product, but Test product III gave the most similar result to that of Control product in the color difference measurement. For the cut lettuce, brownish discoloration was remarkably suppressed especially in Test product III. For the peeled and cut avocado, brownish discoloration was remarkably suppressed especially in Comparative product, and was slightly suppressed in Test product II after 48 hours of storage at 20° C.

That is, for the peeled and cut apple and the cut lettuce, the inventive product was demonstrated to have a higher effect than Comparative product which is a quality-preserving agent for a four component system developed around the same time as the inventive product by Oriental Yeast Co., Ltd. Note that, in a sensory evaluation of the samples, almost similar results were obtained to that of the visual inspection and the color difference measurement.

TABLE 1

| Storage | | | | | |
|---|---|---|---|---|---|
| condition | Sample | Apple | Burdock | Lettuce | Avocado |
| 20° C. × | Non-additive | − | − | − | − |
| 24 h | product | | | | |
| | Test product I | + | + | ++ | + |
| | Test product II | ++ | ++ | +++ | ++ |
| | Test product III | +++++ | ++++ | +++++ | +++ |
| | Comparative | ++++ | +++++ | ++++ | ++++ |
| | product | | | | |
| 20° C. × | Non-additive | − | − | − | − |
| 48 h | product | | | | |
| | Test product I | − | − | − | − |
| | Test product II | − | − | − | + |
| | Test product III | ++++ | ++ | +++ | +++ |
| | Comparative | +++ | +++ | ++ | ++++ |
| | product | | | | |

The larger the number of + is, the lower the extent of discoloration or brownish discoloration is (i.e., more similar to Control product).

TABLE 2

| | Control | Non-additive | Test | Comparative |
|---|---|---|---|---|
| | product | product | product III | product |
| L* | 76.53 | 52.23 | 69.53 | 65.18 |
| a* | −0.88 | 5.96 | 1.22 | 3.36 |
| b* | 16.09 | 33.81 | 21.68 | 31.59 |

TABLE 3

| | Control | Non-additive | Test | Comparative |
|---|---|---|---|---|
| | product | product | product III | product |
| L* | 74.31 | 69.96 | 73.17 | 67.57 |
| a* | −0.35 | 6.91 | 2.34 | 4.57 |
| b* | 15.87 | 21.38 | 18.08 | 25.17 |

TABLE 4

| | Control | Non-additive | Test | Comparative |
|---|---|---|---|---|
| | product | product | product III | product |
| L* | 60.13 | 37.26 | 58.09 | 52.7 |
| a* | −2.09 | 5.9 | −4.56 | −2.81 |
| b* | 9.47 | 26.86 | 26.25 | 22.56 |

TABLE 5

| | Control | Non-additive | Test | Comparative |
|---|---|---|---|---|
| | product | product | product III | product |
| L* | 69.26 | 30.03 | 56.31 | 57.73 |
| a* | −7.67 | 2.67 | 1.57 | 1.8 |
| b* | 34.32 | 12.05 | 34.28 | 35.66 |

### Example 2

### Quality Verification Test of Various Cut Vegetables and Fruits II

The following test was performed to verify the quality-preserving effect of the invention against a peeled and cut avocado, a peeled and cut banana, a cut mushroom, a cut eggplant, a cut Chinese cabbage, a peeled and cut radish, and a peeled and cut peach.

The vegetable or fruit was peeled and/or cut, and optionally sterilized and washed, followed by immersing into each of treatment liquids for 10 min. The following 3 treatment liquids were used: water (“Non-additive”); the inventive product, i.e., a solution prepared to contain, as active ingredients, 1.0% (w/v) of sodium acetate and 0.1% (w/v) of α-lipoic acid (“Test product III of Example 1”); and a solution prepared to contain 0.1% (w/v) of α-lipoic acid (“α-lipoic acid”). After the immersing, the vegetable or fruit was drained and stored at 20° C. for 48 hours or 72 hours. The vegetable or fruit was inspected at the start of storage (initial) and after storage. Results were evaluated by comparing with the visual inspection. Note that, the peeled and cut peach was not treated with the “α-lipoic acid” and was inspected after 7 days of storage.

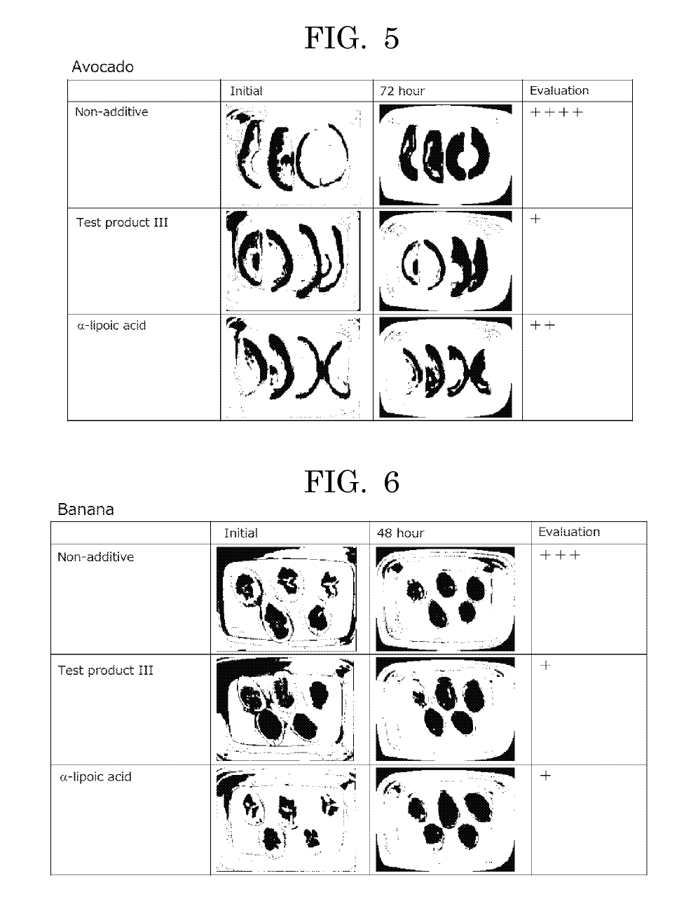

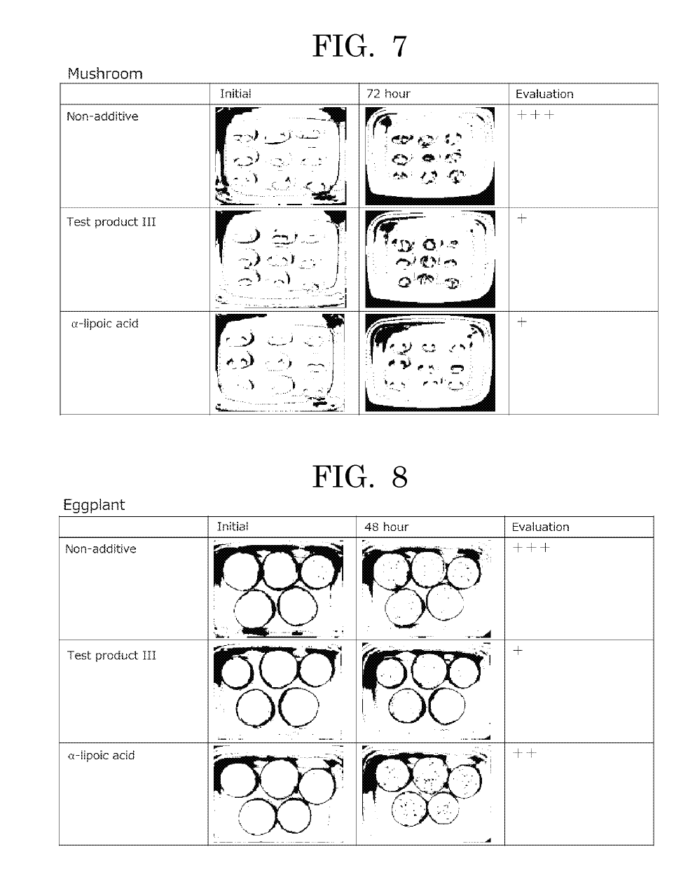

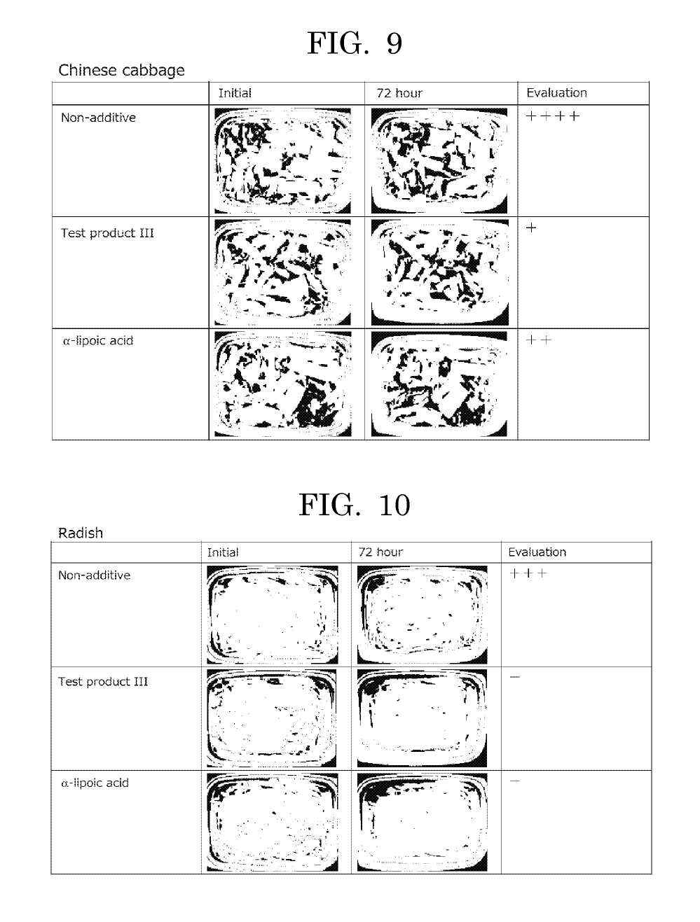

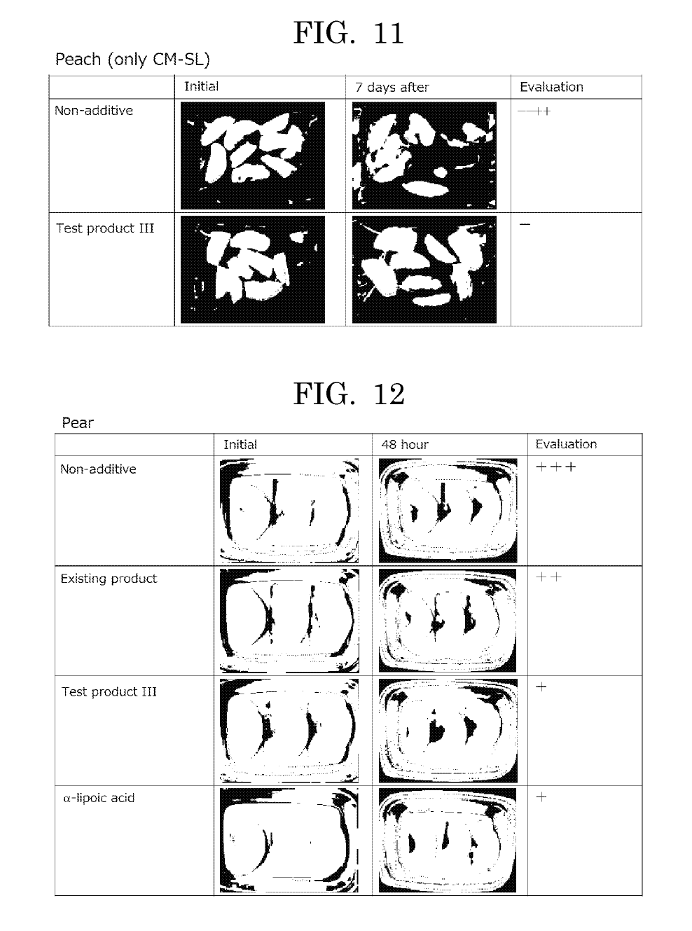

Results are shown in FIGS. 5 to 11. Test product III, which was the inventive product, suppressed brownish discoloration in all of vegetables and fruits compared to Non-additive. Especially, for the peeled and cut avocado, the cut eggplant, and the cut Chinese cabbage, the inventive product was demonstrated to significantly suppress brownish discoloration compared to a treatment with only α-lipoic acid which is a control.

### Example 3

### Quality Verification Test of Various Cut Vegetables and Fruits III

The following test was performed to verify the quality-preserving effect of the invention against a peeled and cut pear, a peeled and cut apple, a cut cabbage, a cut lettuce, a cut crown daisy, a peeled and cut taro, a peeled and cut burdock, a peeled and cut potato, a peeled and cut Chinese yam, and a peeled and cut lotus root.

The vegetable or fruit was peeled and/or cut, and optionally sterilized and washed, followed by immersing into each of treatment liquids for 10 min. The following 4 treatment liquids were used: water (“Non-additive”); Existing product; the inventive product, i.e., a solution prepared to contain, as active ingredients, 1.0% (w/v) of sodium acetate and 0.1% (w/v) of α-lipoic acid (“Test product III of Examples 1 and 2”); and a solution prepared to contain 0.1% (w/v) of α-lipoic acid (“α-lipoic acid”). Note that, the following were used as Existing products: for the peeled and cut pear and the peeled and cut apple, a 1% (w/v) solution of “COOKINGMATE VD” (Oriental Yeast Co., Ltd.) which is a conventional product containing no sodium acetate or α-lipoic acid; for the cut cabbage and the cut lettuce, a 20 times diluted solution of “FRESHRON V10” (Oriental Yeast Co., Ltd.) which is a conventional product containing no sodium acetate or α-lipoic acid; and, for other vegetables or fruits, a 0.4% (w/v) solution of “S-VC” (Oriental Yeast Co., Ltd.) which is a conventional product containing no sodium acetate or α-lipoic acid. After the immersing, the vegetable or fruit was drained and stored 20° C. for 48 hours or 72 hours. The vegetable or fruit was inspected at the start of storage (initial) and after storage. Results were evaluated by comparing with the visual inspection.

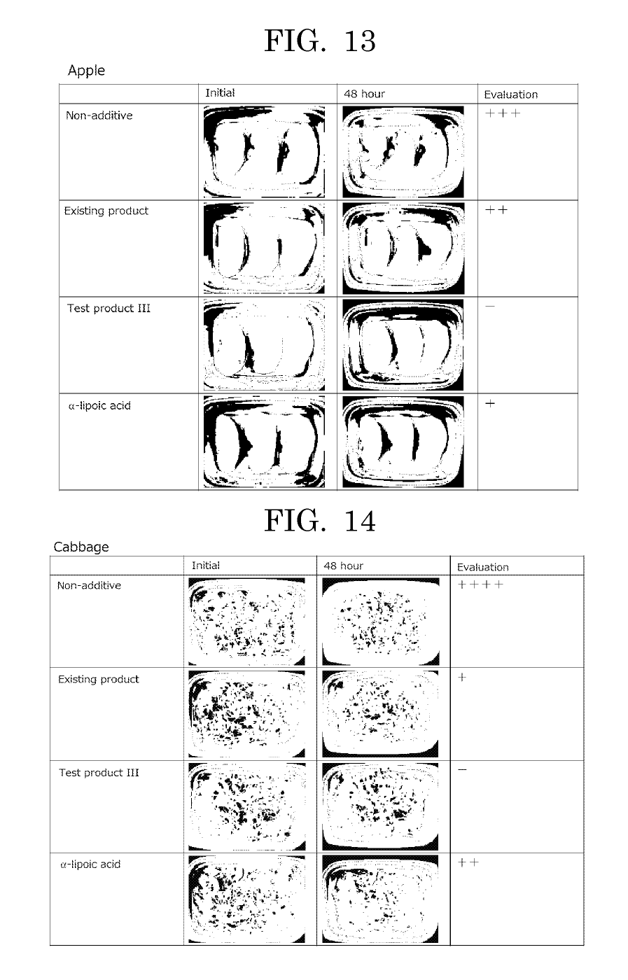

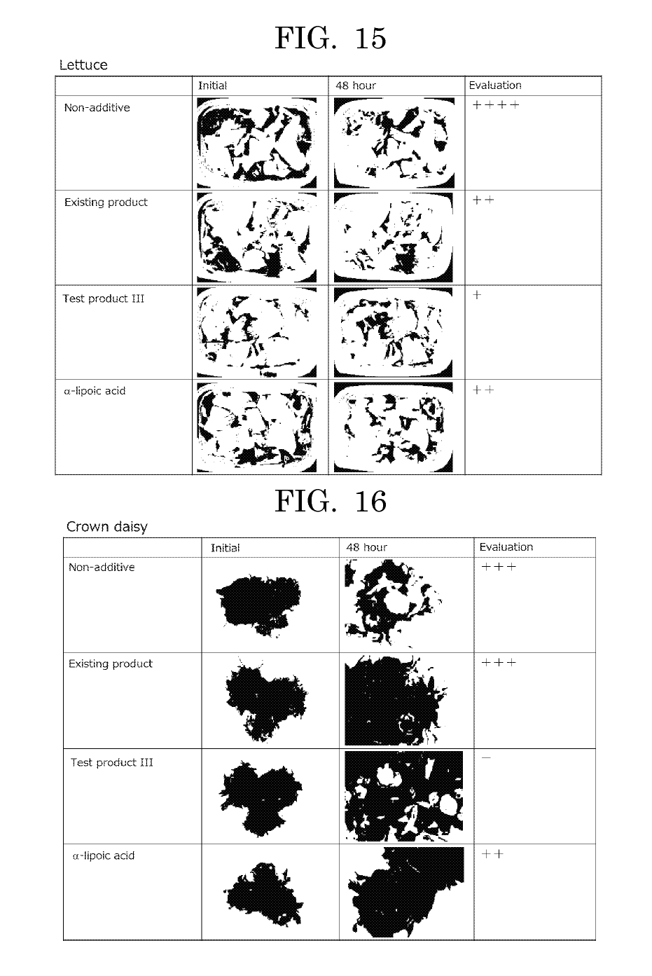

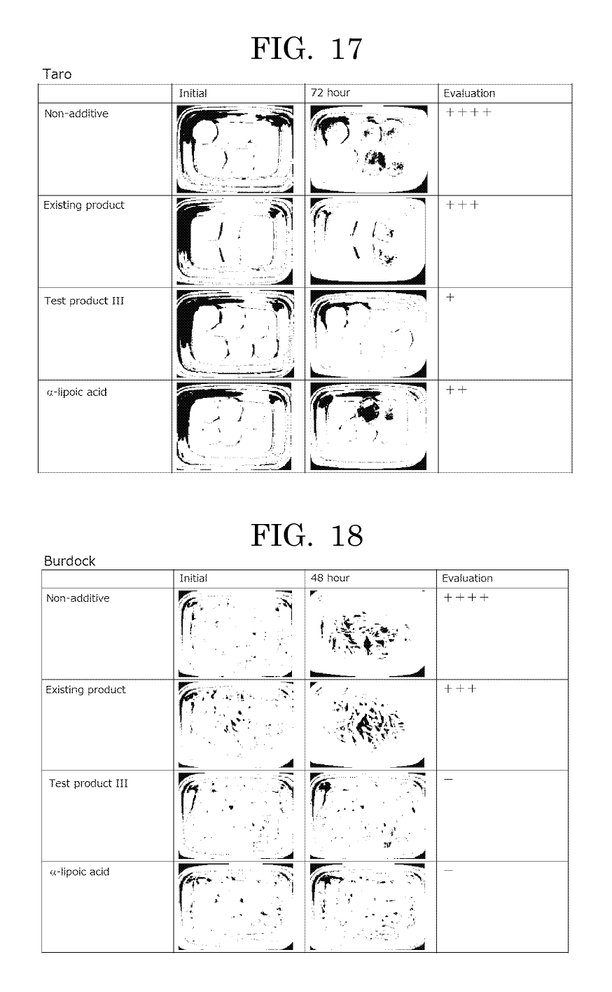

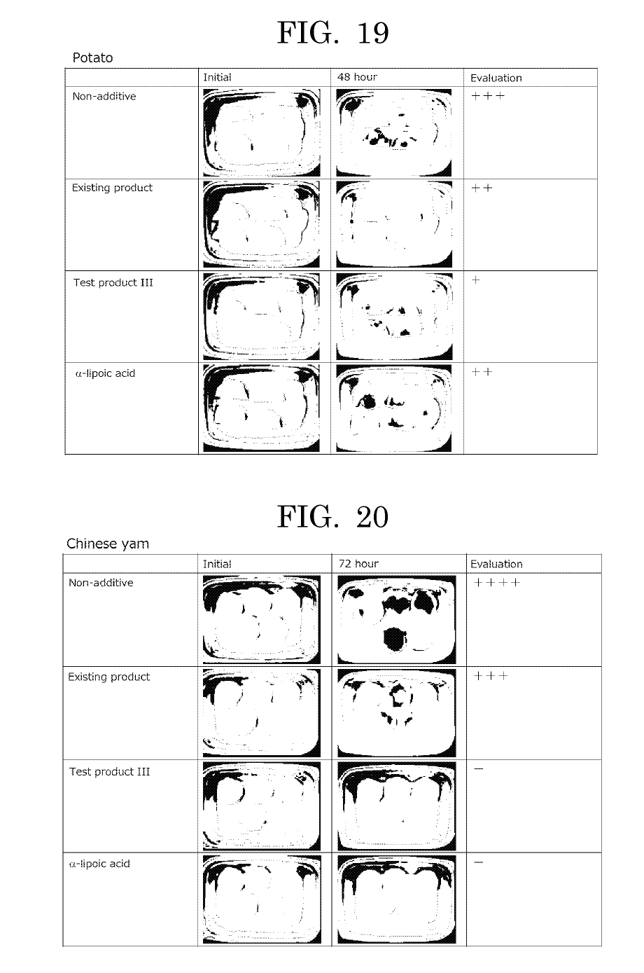

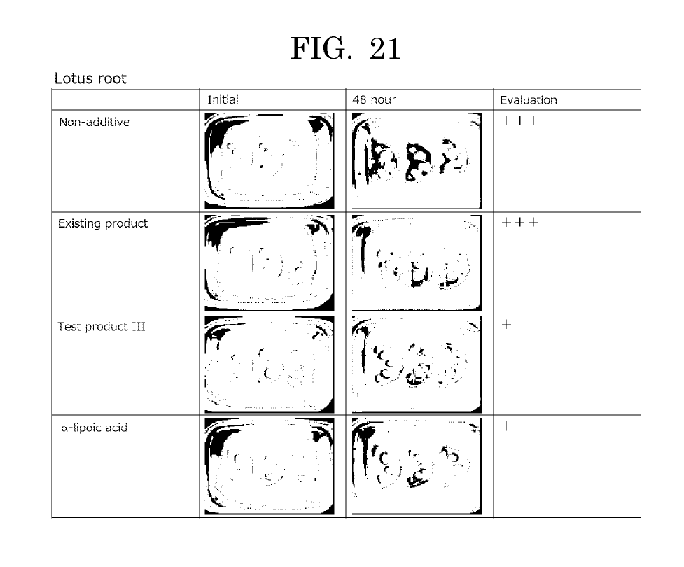

Results are shown in FIGS. 12 to 21. From the results, Test product III, which is the inventive product, suppressed brownish discoloration in all of vegetables and fruits compared to Non-additive and Existing product. Especially, for the peeled and cut apple, the cut cabbage, the cut lettuce, the cut crown daisy, the peeled and cut taro, and the peeled and cut potato, the inventive product was demonstrated to significantly suppress brownish discoloration compared to a treatment with only α-lipoic acid which is another control.

From the above, it has been found that a treatment with a quality-preserving agent according to the invention exhibits a very high brownish discoloration suppression effect and a quality-preserving effect in the various peeled and/or cut vegetables or fruits, and exhibits a satisfactory effect even at an ambient-temperature of 20° C.

The invention is summarized as follows.

An object of the invention is to provide to a novel quality-preserving agent which can preserve the quality of a peeled and/or cut vegetable or fruit or seafood during storage in a simple manner and effectively, and which is highly safe.

The agent contains two components, i.e., sodium acetate and α-lipoic acid, as active ingredients. The agent can prevent discoloration or brownish discoloration of the peeled and/or cut vegetable or fruit or the seafood during chilled storage and ambient-temperature storage, can improve the shelf life, and can preserve the quality in a simple manner and effectively merely by bringing the vegetable, fruit or seafood into contact with the agent.

1. A quality-preserving agent for a peeled and/or cut vegetable or fruit, or seafood, the agent comprising:
sodium acetate; and α-lipoic acid, as active ingredients.

2. The agent according to claim 1, wherein the agent consists of sodium acetate and α-lipoic acid, as the active ingredients.

3. The agent according to claim 1, wherein the agent is brought into contact with the peeled and/or cut vegetable or fruit or the seafood in a form of a solution having a compositional ratio of 0.01% (w/v) to 10.0% (w/v) of sodium acetate and 0.01% (w/v) to 10.0% (w/v) of α-lipoic acid.

4. The agent according to claim 3, wherein the agent is in a form of a solution having a compositional ratio of 0.1% (w/v) to 2.0% (w/v) of sodium acetate and 0.03% (w/v) to 0.5% (w/v) of α-lipoic acid.

5. The agent according to claim 1,
wherein the agent exhibits quality preservation which is prevention of discoloration, improvement of shelf life, or both thereof.

6. The agent according to claim 5, wherein the agent prevents discoloration during storage at 4° C. to 30° C.

7. A method for preserving quality of a peeled and/or cut vegetable or fruit or seafood, the method comprising:
treating the peeled and/or cut vegetable or fruit or the seafood with a solution containing, as active ingredients, 0.01% (w/v) to 10.0% (w/v) of sodium acetate and 0.01% (w/v) to 10.0% (w/v) of α-lipoic acid through at least one selected from the group consisting of immersion, spraying, and coating.

8. The method according to claim 7, wherein the solution is a solution containing, as active ingredients, 0.1% (w/v) to 2.0% (w/v) of sodium acetate and 0.03% (w/v) to 0.5% (w/v) of α-lipoic acid.

9. The method according to claim 7, wherein the method exhibits quality preservation which is prevention of discoloration, improvement of shelf life, or both thereof.

10. The method according to claim 9, wherein the method prevents discoloration during storage at 4° C. to 30° C.

11. The agent according to claim 2, wherein the agent is brought into contact with the peeled and/or cut vegetable or fruit or the seafood in a form of a solution having a compositional ratio of 0.01% (w/v) to 10.0% (w/v) of sodium acetate and 0.01% (w/v) to 10.0% (w/v) of α-lipoic acid.

12. The agent according to claim 11, wherein the agent is in a form of a solution having a compositional ratio of 0.1% (w/v) to 2.0% (w/v) of sodium acetate and 0.03% (w/v) to 0.5% (w/v) of α-lipoic acid.

13. The agent according to claim 2, wherein the agent exhibits quality preservation which is prevention of discoloration, improvement of shelf life, or both thereof.

14. The agent according to claim 3, wherein the agent exhibits quality preservation which is prevention of discoloration, improvement of shelf life, or both thereof.

15. The agent according to claim 4, wherein the agent exhibits quality preservation which is prevention of discoloration, improvement of shelf life, or both thereof.

16. The agent according to claim 13, wherein the agent prevents discoloration during storage at 4° C. to 30° C.

17. The agent according to claim 14, wherein the agent prevents discoloration during storage at 4° C. to 30° C.

18. The agent according to claim 15, wherein the agent prevents discoloration during storage at 4° C. to 30° C.

19. The method according to claim 8, wherein the method exhibits quality preservation which is prevention of discoloration, improvement of shelf life, or both thereof.

20. The method according to claim 19, wherein the method prevents discoloration during storage at 4° C. to 30° C.
